(19) United States
(12) Patent Application Publication
(10) Pub. No.: US 2023/0143467 A1
(43) Pub. Date: May 11, 2023

(54) Method and Device for Supporting a Refueling Process of a Vehicle Having a Fuel Cell

(71) Applicant: Bayerische Motoren Werke Aktiengesellschaft, Muenchen (DE)

(72) Inventor: Andreas PELGER, Ismaning (DE)

(21) Appl. No.: 17/917,870

(22) PCT Filed: Mar. 11, 2021
(86) PCT No.: PCT/EP2021/056141

§ 371 Date: Oct. 7, 2022

(30) Foreign Application Priority Data
Apr. 9, 2020 (DE) 10 2020 110 008.6

(51) Int. Cl. H01M 8/04303; H01M 8/04082; H01M 8/0432; B60L 50/75; B60L 58/40; B60L 58/30; H01M 8/04223; H01M 8/04228

(52) U.S. Cl. CPC H01M 8/04303; H01M 8/04201; H01M 8/0432; B60L 50/75; B60L 58/40; B60L 58/30; H01M 8/04253; H01M 8/04228; H01M 2250/20; B60L 2260/56; B60L 2250/12; B60L 2240/62; B60L 2240/662; B60L 2240/80

(57) ABSTRACT

A device supports a refueling process of a vehicle having a fuel cell, wherein the vehicle is configured to carry out a switch-off process of the fuel cell prior to the refueling process. The device includes a control unit that determines that a refueling process shall be carried out. The control unit also, in response to the determination, performs one or more measures that reduce a delay time period for starting the refueling process caused by the switch-off process of the fuel cell.

### CROSS REFERENCE TO RELATED APPLICATION

This application is a 371 of International Application No. PCT/EP2021/056141, filed Mar. 11, 2021 which claims priority under 35 U.S.C. § 119 from German Patent Application No. 10 2020 110 008.6, filed Apr. 9, 2020, the entire disclosure of which is herein expressly incorporated by reference.

### BACKGROUND AND SUMMARY OF THE INVENTION

The technology disclosed herein relates to a method and a corresponding device for supporting a user of a vehicle having a fuel cell system or having a fuel cell in a refueling process.

An electrically driven vehicle can comprise a fuel cell system with a fuel cell which is configured to generate electrical energy for an electric drive motor of the vehicle on the basis of a fuel cell, in particular on the basis of hydrogen. The vehicle comprises a tank, in particular a pressure tank, for holding the fuel, wherein the tank can be filled with fuel as part of a refueling process at a refueling station.

Before a refueling process, a switch-off process of the fuel cell system, in particular of the fuel cell, is typically carried out in order to allow a safe refueling process. The switch-off process can also be referred to as a shutdown. The switch-off process can take a relatively long time, especially at relatively low ambient temperatures (around or below freezing), which means that the user of the vehicle has to wait a relatively long time for the switch-off process to be completed before the refueling process can be started.

It is a preferred object of the technology disclosed herein to reduce or eliminate at least one disadvantage of a previously known solution or to propose an alternative solution. In particular, it is a preferred object of the technology disclosed herein to reduce the waiting time before starting a refueling process of a vehicle having a fuel cell. Further preferred objects may result from the advantageous effects of the technology disclosed herein. The object is achieved by the subject matter of the independent claims. The dependent claims describe preferred embodiments.

According to one aspect, a device for supporting a refueling process of a vehicle having a fuel cell is described. The fuel cell can be supplied with a fuel, in particular hydrogen, or rather H₂. As part of the refueling process, fuel can be added to a fuel tank of the vehicle to increase the fill level of the fuel tank.

Before starting the refueling process, typically (for example for safety reasons) a switch-off process of the fuel cell has to be carried out. This switch-off process can take a relatively long time, especially at relatively low ambient temperatures (for example at 5° C. or less), since in this case a so-called winter switch-off process and/or a conditioning of the fuel cell has to be carried out.

The device is designed to determine that a refueling process shall be carried out. In particular, the device can be designed to determine that a refueling process shall be carried out during the current stop of the vehicle (if the vehicle is already stationary) or at the vehicle's next stop ahead (if the vehicle is still moving). Furthermore, the device can be designed to determine a time period ahead and/or a location ahead, in the direction of travel of the vehicle, at which the refueling process shall be carried out.

The device can be designed to determine fill level information relating to the fill level of the fuel tank of the vehicle (indicating, for example, that the vehicle will need to be refueled in the relatively near future because the fill level is below a fill level threshold value). Alternatively or additionally, the device can be designed to determine navigation information relating to a planned route of the vehicle (indicating, for example, that the vehicle is on its way to a refueling station). Alternatively or additionally, the device can be designed to determine usage information relating to a typical usage of the vehicle in the past (indicating, for example, that the user always refuels the vehicle at a certain time or on a certain day of the week and/or at a certain location).

Alternatively or additionally, the device can be designed to determine sensor data relating to the vehicle's surroundings. The sensor data (in particular the image data of a camera) can indicate, for example, that the vehicle is moving towards a refueling station. Alternatively or additionally, the device can be designed to determine communication data relating to a communication of the vehicle with a refueling station for the refueling process. For example, it can be determined that a fuel pump has been reserved at the refueling station as part of the communication.

The device can be designed to determine on the basis of the fill level information, on the basis of the navigation information, on the basis of the usage information, on the basis of the sensor data and/or on the basis of the communication data that (as part of the vehicle's next stop) a refueling process shall be carried out. In this way, a refueling process ahead can be predicted in a particularly precise manner.

Alternatively or additionally, the device can be designed to determine, on the basis of an input (for example a control input and/or a voice input) of the user at a user interface of the vehicle, that (as part of the vehicle's next stop) a refueling process shall be carried out. For example, the user may have communicated via an input that a refueling process shall be carried out. The input can be made here directly by the user or can be provided in response to a request from the device to the user (for example because a refueling process has been predicted by the device). By including the user, a planned refueling process can be predicted in a particularly precise manner.

The device is further designed, in response to it having been determined that a refueling process shall be carried out (as part of the stop already made by the vehicle or the vehicle's next stop yet to be made), to perform one or more measures aimed at reducing the delay time period for the start of the refueling process that is caused by the switch-off process of the fuel cell. Here, the delay time period may be the duration between the time at which the vehicle is stopped and the earliest possible time for the start of the refueling process (once the switch-off process of the fuel cell has been completed).

The (possibly early) recognition of the fact that a refueling process will be carried out as part of the (already made or next) stop of the vehicle (and thus the vehicle is not expected to be permanently parked) makes it possible to carry out one or more measures to reduce the delay time period, so that the comfort for the user of the vehicle can be increased and/or so that the aging of the fuel cell due to the execution of (possibly unnecessary) switch-off processes can be reduced.

The device can be designed, as a measure for reducing the delay time period, to prevent a prolonged winter switch-off process if it has been determined that a refueling process shall be carried out (as part of the stop of the vehicle). Alternatively or additionally, the device can be designed, as a measure for reducing the delay time period, to prevent a conditioning of the fuel cell (to remove water residues in the fuel cell) if it has been determined that a refueling process shall be carried out (as part of the stop of the vehicle). The conditioning of the fuel cell can be designed to adjust or regulate the water balance of the fuel cell. In this context, the fuel cell can be dehumidified (in particular at relatively cold temperatures) in order to protect the fuel cell in the stopped state (in particular when parked). The conditioning of the fuel cell can thus comprise the drying or a dehumidification of the fuel cell.

The device can in particular be designed to determine temperature information relating to the ambient temperature in the (possibly direct) environment of the fuel cell. It can then be determined on the basis of the temperature information that a winter switch-off process and/or a conditioning (in particular a drying) of the fuel cell is to be carried out (in particular if the fuel cell is switched off for longer than an allowable maximum time period). Here, the allowable maximum time period can be dependent on the ambient temperature. Typically, the allowable maximum time period increases as the ambient temperature increases. The allowable maximum time period can be determined by the device.

The device can be designed, for example, to determine that a winter switch-off process and/or a conditioning (in particular a drying or dehumidification) of the fuel cell is to be carried out if it is identified on the basis of the temperature information that the ambient temperature is less than or equal to a specific temperature threshold value (for example 5° C.).

The device can also be designed to nevertheless prevent the execution of the winter switch-off process and/or the conditioning (in particular the drying) of the fuel cell if it has been determined that (as part of the stop of the vehicle) a refueling process shall be carried out (and thus it is to be expected that the fuel cell will be reactivated again within the allowable maximum time period).

By eliminating the relatively lengthy winter switch-off process and/or the relatively lengthy conditioning of the fuel cell, the delay time period until the possible start of the refueling process can be significantly reduced. Furthermore, the aging of the fuel cell can be reduced. Instead of the winter switch-off process, a normal or standard switch-off process is then typically carried out (in which no or only partial conditioning (in particular drying) of the fuel cell takes place).

The device can be designed to check, after execution of the (standard) switch-off process of the fuel cell, whether the fuel cell has been reactivated again at the latest by the end of the allowable maximum time period. Furthermore, the device can be designed to initiate the execution of at least part of the winter switch-off process and/or the (possibly complete) conditioning (in particular drying) of the fuel cell if it is identified that the fuel cell has not been reactivated within the allowable maximum time period. In this way, any detrimental effect on the fuel cell can be reliably avoided.

The device can be designed to determine that a refueling process shall be carried out at a time period ahead and/or at a location ahead in the direction of travel of the vehicle. Thus, it can be predicted in advance that (at the next refueling stop) a refueling process shall be carried out.

Then, as a measure for reducing the delay time period, the switch-off process of the fuel cell can be caused to start already temporally before the time period ahead and/or already before reaching the location ahead for the refueling process. Thus, the switch-off process can be started already before the vehicle stops and/or already before the refueling station is reached (so that the remaining time of the switch-off process after the vehicle stops can be reduced). The start of the switch-off process of the fuel cell can have the (direct) consequence here that no more electrical energy is generated by the fuel cell.

The device can further be designed, as a measure for reducing the delay time period, to cause the electric drive motor of the vehicle to be operated from the start of the switch-off process of the fuel cell (optionally exclusively) with electric energy from the electric energy storage device of the vehicle (for example from a high-voltage storage device) in order to move the vehicle to the location ahead for the refueling process. The vehicle can thus be operated (optionally solely) from the electric energy storage device until it reaches the refueling station.

By initiating the switch-off process of the fuel cell in good time, the delay time period until the possible start of the refueling process can be reliably reduced (and possibly completely avoided).

The device can be designed to determine the necessary switch-off time for carrying out the switch-off process of the fuel cell. The switch-off time can depend here on the state of the fuel cell and/or on the ambient temperature in the vicinity of the fuel cell.

The switch-off process can be started at a time and/or at a location (before reaching the refueling station for the refueling process) dependent on the determined switch-off time. The time and/or the location for the start of the switch-off process of the fuel cell can be determined here depending on the determined switch-off time in such a way that the switch-off process is ended at the exact time when the vehicle stops for the refueling process and/or at the exact time when a user typically wishes to start the refueling process after the vehicle has stopped. In this way, the delay time period can be reduced to zero in a resource-efficient manner.

The device can be designed to determine information relating to the duration and/or the distance of a journey following the refueling process. This information may be determined, for example, on the basis of navigation information and/or on the basis of usage information of the vehicle. The device can further be designed to carry out or prevent a reactivation of the fuel cell following the refueling process depending on the determined information. In particular, a reactivation of the fuel cell can be prevented during a relatively short journey following the refueling process. Thus, the aging of the fuel cell due to the execution of switch-off processes can be reduced.

According to a further aspect, a (road) motor vehicle (in particular a passenger car or a truck or a bus) comprising the device described in this document is described.

According to a further aspect, a method for supporting a refueling process of a vehicle having a fuel cell is described, wherein a switch-off process of the fuel cell is to be carried out prior to the refueling process. The switch-off process may, for example, require a switch-off time of between 10 seconds and 60 seconds. The switch-off time may depend here on the state of the fuel cell and/or on the ambient temperature.

The method comprises determining that (as part of the current or next vehicle stop) a refueling process shall be carried out. Furthermore, in response thereto, the method comprises a step of performing one or more measures aimed at reducing the delay time period for the start of the refueling process that is caused by the switch-off process of the fuel cell. Here, the one or more measures can be performed selectively (optionally only) in the event that it has been identified that a refueling process shall be carried out when the vehicle is stopped. The one or more measures optionally cannot be carried out if it has been identified that a stop of the vehicle without a refueling process shall be made or is currently being made.

According to a further aspect, a software (SW) program is described. The SW program can be designed to be run on a processor and thereby to perform the method described in this document.

According to a further aspect, a storage medium is described. The storage medium can comprise an SW program designed to be run on a processor and thereby to carry out the method described in this document.

It should be noted that the methods, devices, and systems described in this document can be used alone or in combination with other methods, devices, and systems described in this document. Furthermore, any aspects of the methods, devices, and systems described in this document can be combined with one another in a variety of ways. In particular, the features of the claims can be combined in a variety of ways.

The invention will be described hereinafter in greater detail with reference to exemplary embodiments. In the figures

### BRIEF DESCRIPTION OF THE DRAWINGS

FIG. 1a shows exemplary components of a vehicle;

FIG. 1b shows an exemplary system for carrying out a refueling process; and

FIG. 2 shows a flow diagram of an exemplary method for carrying out a refueling process of a vehicle having a fuel cell.

### DETAILED DESCRIPTION OF THE DRAWINGS

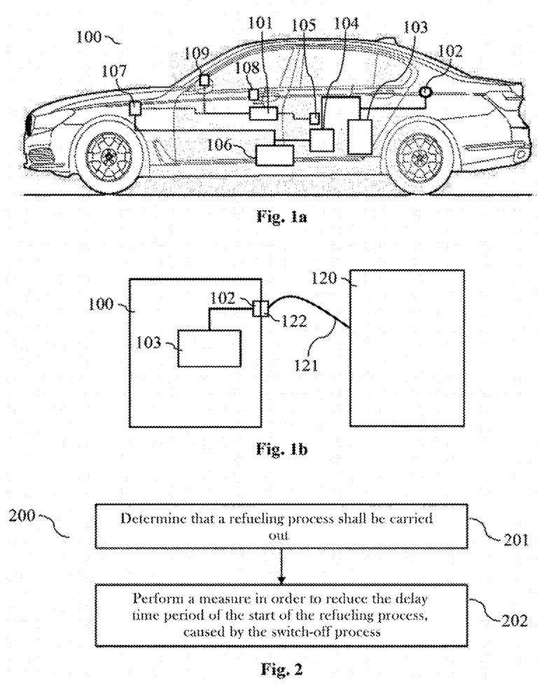

As stated at the outset, the present document is concerned with increasing the convenience of a refueling process for refueling the fuel tank of a fuel cell system of a vehicle. In this context, FIG. 1a shows an exemplary vehicle 100. The vehicle 100 comprises a fuel tank 103, in particular a pressure tank, for holding a fuel, in particular hydrogen. The tank 103 can be refueled via a coupling element 102, which, for a refueling process, is configured to be connected to a complementary coupling element 122 on a refueling hose 121 of a refueling station 120 (see FIG. 1b).

The fuel from the tank 103 can be used to power a fuel cell 104 of the vehicle 100 in order to generate electrical energy that can be stored in an electrical energy storage device 106 of the vehicle 100 and/or that can be used to power an electric drive motor 107 of the vehicle 100.

Typically, before a refueling process of the tank 103 can be carried out, the fuel cell 104 must first be switched off or disconnected. A switch-off process can be carried out for this purpose. The switch-off process can be designed to place the fuel cell 104 in a switched-off state in which the fuel cell 104 is as protected as possible from detrimental effects caused by environmental degradation.

The switch-off process can depend on current ambient conditions of the fuel cell 104 or the vehicle 100. In particular, the switch-off process can include drying the anode of the fuel cell 104 at relatively low ambient temperatures (particularly at or below freezing) to remove water from the fuel cell 104 (which might cause damage to the fuel cell 104 by freezing). Thus, the time period of the switch-off process can be relatively long (for example, 30 seconds or longer), particularly at relatively low ambient temperatures.

The switch-off process of the fuel cell 104 can be caused by one or more actuators 105 (for example, a fan). The control unit 101 of the vehicle 100 can be designed to operate the one or more actuators 105 to carry out the switch-off process. Furthermore, the control unit 101 can be designed to identify that the switch-off process has been completed. In response, a refueling process for refueling the fuel tank 103 can be enabled.

Carrying out the switch-off process of the fuel cell 104, particularly at relatively low ambient temperatures, may thus require the user of the vehicle 100 to wait a relatively long time after parking or stopping the vehicle 100 at a refueling station 102 before the refueling process of the tank 103 can be started. This is typically inconvenient for the user of the vehicle 100.

The control unit 101 can be designed to determine that a refueling process should be carried out before reaching a refueling station 120 or upon reaching a refueling station 120. For example, it can be predicted or determined that a refueling process shall be carried out on the basis of the current fill level of the tank 103, on the basis of a planned route of the vehicle 100 in a navigation device 108 of the vehicle, on the basis of historical usage data of the vehicle 100, on the basis of vehicle-to-infrastructure communication (for example, between the vehicle 100 and a refueling station 120), or on the basis of the evaluation of sensor data from one or more environmental sensors (in particular cameras) of the vehicle 100. In particular, it can be predicted that a refueling process of the vehicle 100 will be carried out within a certain time period ahead (for example, of 10 minutes or less).

Alternatively or additionally, the user of the vehicle 100 can be allowed to indicate that a refueling process shall be carried out via a user interface 109 of the vehicle 100. For this purpose, a control input can be made at a control element of the user interface 109 and/or a voice input of the user can be provided.

Alternatively or additionally, the user interface 109 of the vehicle 100 can be used to question (for example, in response to the aforementioned prediction of a refueling process ahead) whether or not a refueling process should actually be carried out. It can then be possible for the user to indicate via the user interface 109 (for example, by a control input and/or by a voice input) whether or not a refueling process should be carried out.

The control unit 101 can thus be designed to determine that (within a certain time period ahead) a refueling process of the vehicle 100 shall be carried out. One or more measures can then be performed in order to reduce (or, if possible, avoid altogether) the delay time period between the vehicle 100 being parked at the refueling station 120 and the possible start of the refueling process.

An exemplary measure in this regard is to switch off the fuel cell 104 regardless of the ambient temperature and/or even at relatively low ambient temperatures using a (standard) switch-off process for relatively high ambient temperatures. In particular, only a normal or standard switch-off process can be carried out, even in winter (and not the relatively time-consuming winter switch-off process or winter shutdown). It can be assumed here that after the refueling of the tank 103, the fuel cell 104 is directly restarted or reactivated, so that the fuel cell 104 is not expected to cool down (and thus might be damaged by the remaining water in the fuel cell 104).

The control unit 101 can be designed to check whether a refueling process is actually carried out and/or whether the fuel cell 104 is reactivated within a specified, allowable, maximum switch-off period. If it is identified that the fuel cell 104 has not been reactivated within the specified stopped period, then the winter switch-off process can be performed subsequently to avoid any detrimental effect to the fuel cell 104.

Alternatively or additionally, as a measure, the switch-off process of the fuel cell 104 can be made to start already during the approach (at a certain physical distance (for example, 100 meters) and/or temporal distance (for example, 30-60 seconds)) prior to reaching the refueling station 120. The vehicle 100 can then be operated the remaining distance to the refueling station 120 (optionally solely) based on the electrical energy from the electrical energy storage device 106. In this way, the switch-off process can thus be finished before the user wishes to begin the refueling process.

The control unit 101 can be designed to determine the distance that the vehicle 100 will travel following the refueling process until the vehicle 100 is stopped again. For example, it can be determined that the vehicle 100 will travel to the user's residence following the refueling process.

If it is identified that only a relatively short distance will be traveled following the refueling process, which can be traveled solely using electrical energy from the electrical energy storage device 106, then the restart of the fuel cell 104 can be prevented. In this way, a re-execution of the switch-off process, the associated energy consumption, and the associated aging of the fuel cell 104 can be avoided.

FIG. 2 shows a flow diagram of an exemplary (possibly computer-implemented) method 200 for supporting a refueling process of a vehicle 100 having a fuel cell 104. In a vehicle 100 having a fuel cell 104, it is typically necessary to perform a switch-off process of the fuel cell 104 before starting the refueling process. In this regard, the switch-off process may take a relatively long period of time, particularly in winter or at relatively low temperatures (in order to perform a drying of the fuel cell).

The method 200 comprises determining 201 that a refueling process shall be carried out. For this purpose, data from a navigation system 108 of the vehicle 100, for example, and/or data relating to the fill level of the fuel tank 103 of the vehicle 100 and/or a user input at a user interface 109 of the vehicle 100 can be considered and/or evaluated. In particular, it can be determined within the scope of the method 200 that the vehicle 100 will perform a refueling process during the stop that has already been made or at the next stop.

Furthermore, in response thereto, the method 200 comprises performing 202 one or more measures aimed at reducing the delay time period for the start of the refueling process caused by execution of the switch-off process of the fuel cell 104. In other words, the one or more measures may help to start the refueling process as soon as possible after the vehicle is stopped so that the user does not have to wait for the switch-off process of the fuel cell to complete, or only has to wait for a reduced time period.

To reduce the delay time period between the stopping of the vehicle and the possible start of the refueling process, the switch-off process can be started already while the vehicle is still moving, before it reaches the refueling station for the refueling process. Alternatively or additionally, instead of a winter switch-off process, a normal or standard switch-off process can be carried out (wherein the standard switch-off process is typically quicker than the winter switch-off process), even if it would seem necessary to carry out the winter switch-off process due to the temperature conditions in the environment of the vehicle.

The method 200 described in this document can accelerate the readiness for refueling of a vehicle 100 having a fuel cell 104. Furthermore, the number of winter switch-off processes of a fuel cell 104, the associated load or aging of the fuel cell 104, and the associated energy consumption can be reduced. Thus, the service life of a fuel cell 104 can be increased.

Within the scope of a switch-off process, water may be purged from the exhaust system of the fuel cell 104, if necessary, which may result in water accumulation on the ground at the refueling station 120 and possibly ice formation in winter (especially if multiple vehicles 100 are refueled in succession at the same refueling station 120). By performing the switch-off process in good time before reaching the refueling station 120, such water accumulations can be avoided or at least reduced.

The present invention is not limited to the exemplary embodiments shown. In particular, it should be noted that the description and figures are intended to illustrate the principle of the proposed methods, devices and systems merely by way of example.

1-11. (canceled)

12. A device for supporting a refueling process of a vehicle having a fuel cell, wherein the vehicle is configured to carry out a switch-off process of the fuel cell prior to the refueling process, the device comprising:
a control unit configured to:
determine that a refueling process shall be carried out; and
to perform, in response to the determination, one or more measures that reduce a delay time period for starting the refueling process caused by the switch-off process of the fuel cell.

13. The device of claim 12, wherein the one or more measures includes: preventing an extended winter switch-off process, and/or preventing conditioning of the fuel cell.

14. The device of claim 13, wherein the control unit is further configured to, after performing the switch-off process of the fuel cell:
check whether the fuel cell has been reactivated no later than the expiration of an allowable maximum time period; and
initiate the execution of at least a part of the winter switch-off process and/or the conditioning of the fuel cell, if it is recognized that the fuel cell has not been reactivated within the allowable maximum time period.

15. The device of claim 13, wherein the control unit is further configured to:
determine temperature information relating to an ambient temperature in an environment of the fuel cell;
determine, based on the temperature information, that a winter switch-off process and/or a conditioning of the fuel cell is to be carried out when the fuel cell is switched off for longer than an allowable maximum time period; and
to nevertheless prevent the execution of the winter switch-off process and/or the conditioning of the fuel cell, if it has been determined that the refueling process shall be carried out.

16. The device of claim 12, wherein the control unit is configured to:
determine that the refueling process shall be carried out at a time period ahead and/or at a location ahead in the direction of travel of the vehicle,
wherein the one or more measures includes: causing the switch-off process of the fuel cell to be started before the time period ahead and/or before the location ahead is reached.

17. The device according to claim 16, wherein the one or more measures includes: causing an electric drive motor of the vehicle to be powered by electric energy from an electric energy storage device of the vehicle from the start of the switch-off process of the fuel cell, in order to move the vehicle to the location ahead for refueling.

18. The device of claims 16, wherein the control unit is further configured to:
determine a required switch-off time period for carrying out the switch-off process of the fuel cell; and
start the switch-off process at a time and/or at a location dependent on the determined switch-off time period.

19. The device of claim 12, wherein the control unit is further configured to:
determine:
fill level information relating to a fill level of a fuel tank of the vehicle,
navigation information relating to a planned route of travel of the vehicle,
usage information relating to a typical usage of the vehicle in the past,
sensor data relating to an environment of the vehicle, and/or
communication data relating to a communication of the vehicle with a refueling station for the refueling process; and
determine, on the basis of the fill level information, the navigation information, the usage information, the sensor data, and/or the communication data, that the refueling process shall be carried out.

20. The device of claim 12, wherein the control unit is further configured to: determine, on the basis of an input by a user at a user interface of the vehicle, that the refueling process shall be carried out.

21. The device of claim 12, wherein the control unit is further configured to:
determine information relating to a duration and/or a distance of a journey following the refueling process; and
carry out or prevent a reactivation of the fuel cell following the refueling process depending on the determined information.

22. A method for supporting a refueling process of a vehicle having a fuel cell, wherein a switch-off process of the fuel cell is to be carried out prior to the refueling process, wherein the method comprises:
determining that a refueling process shall be carried out; and
performing, in response to the determination, one or more measures that reduce a delay time period for starting the refueling process caused by the switch-off process of the fuel cell.
